(19) United States
(12) Patent Application Publication
(10) Pub. No.: US 2025/0392717 A1
(43) Pub. Date: Dec. 25, 2025

(54) Method and Apparatus of Dependent Quantization for Video Coding

(71) Applicant: MEDIATEK INC., Hsinchu City (TW)

(72) Inventors: Tzu-Der CHUANG, Hsinchu City (TW); Ching-Yeh CHEN, Hsinchu City (TW); Chih-Wei HSU, Hsinchu City (TW)

(21) Appl. No.: 18/879,434

(22) PCT Filed: Jul. 4, 2023
(86) PCT No.: PCT/CN2023/105663

§ 371 Date: Dec. 27, 2024

Related U.S. Application Data
(60) Provisional application No. 63/367,654, filed on Jul. 5, 2022.

(51) Int. Cl. H04N 19/124; H04N 19/119; H04N 19/176; H04N 19/18

(52) U.S. Cl. CPC H04N 19/124; H04N 19/119; H04N 19/176; H04N 19/18

(57) ABSTRACT

A method and apparatus for video coding using dependent quantization (DQ) with sign hiding. At the decoder side, for a current segment, a sign-hiding state of a selected coefficient, or parity information of the quantized transform coefficients associated with the current segment, or both are determined. The current segment comprises a sign-hiding coefficient. The signs associated with one or more sign-hiding quantization coefficients corresponding to one or more target coefficients in the current segment are determined based on the sign-hiding state, the parity information of the current segment, or both. The quantization coefficients with the signs recovered are dequantized using respective quantizers from the plurality of quantizers. A method and apparatus for a corresponding encoder are also disclosed.

### CROSS REFERENCE TO RELATED APPLICATIONS

The present invention is a non-Provisional Application of and claims priority to U.S. Provisional Patent Application No. 63/367,654, filed on Jul. 5, 2022. The U.S. Provisional Patent Application is hereby incorporated by reference in its entirety.

### FIELD OF THE INVENTION

The present invention relates to video coding system using dependent quantization coding tool. In particular, the present invention relates to schemes allowing dependent quantization with sign data hiding capability.

### BACKGROUND

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology—Coded representation of immersive media—Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video coding system incorporating loop processing. For Intra Prediction, the prediction data is derived based on previously coded video data in the current picture. For Inter Prediction 112, Motion Estimation (ME) is performed at the encoder side and Motion Compensation (MC) is performed based of the result of ME to provide prediction data derived from other picture(s) and motion data. Switch 114 selects Intra Prediction 110 or Inter-Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, are provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

According to VVC, an input picture is partitioned into non-overlapped square block regions referred as CTUs (Coding Tree Units), similar to HEVC. Each CTU can be partitioned into one or multiple smaller size coding units (CUs). The resulting CU partitions can be in square or rectangular shapes. Also, VVC divides a CTU into prediction units (PUs) as a unit to apply prediction process, such as Inter prediction, Intra prediction, etc.

The VVC standard incorporates various new coding tools to further improve the coding efficiency over the HEVC standard. Among various new coding tools, some coding tools relevant to the present invention are reviewed as follows. In particular, VVC adopts dependent quantization as a way to improve coding performance. While the dependent quantization can improve coding performance, the sign bit hiding tool is turned off due to the constraint of dependent quantization. Accordingly, the present invention discloses schemes that allow the dependent quantization to incorporate sign bit hiding to further improve the coding efficiency of dependent quantization.

### BRIEF SUMMARY OF THE INVENTION

A method and apparatus for quantizing transform coefficients are disclosed. According to the method, at an encoder side, transform coefficients of a residual block are determined. The transform coefficients of the residual block are divided into one or more segments with a predefined number or range of transform coefficients for each of said one or more segments. A plurality of states and a plurality of quantizers corresponding to dependent quantization for the transform coefficients of the residual block are identified. For a current segment of said one or more segments, the quantized coefficients associated with the transform coefficients in the current segment is determined, wherein a sign-hiding state of a selected coefficient, parity information of the current segment, or both are indicative of one or more signs associated with one or more sign-hiding quantization coefficients corresponding to one or more target coefficients in the current segment. Said one or more sign-hiding quantization coefficients are encoded without signalling said one or more signs associated with said one or more sign-hiding quantization coefficients. The proposed method and apparatus can also be applied to encode the transform skipped block.

At the decoder side, quantization coefficients associated with transform coefficients of a residual block are received, wherein the quantization coefficients are divided into one or more segments with a predefined number or range of transform coefficients for each of said one or more segments, and wherein one or more signs associated with one or more sign-hiding quantization coefficients corresponding to one or more target coefficients in a current segment are not signalled or parsed. A plurality of states and a plurality of quantizers corresponding to dependent quantization used for quantizing transform coefficients of the residual block are identified. For the current segment, a sign-hiding state of a selected coefficient is determined, or determining parity information of the quantized coefficients of the current segment, or determining both. Said one or more signs associated with said one or more sign-hiding quantization coefficients corresponding to said one or more target coefficients in the current segment are determined based on the sign-hiding state, the parity information of the current segment, or both. The quantization coefficients with said one or more signs recovered are dequantized using respective quantizers from the plurality of quantizers. The proposed method and apparatus can also be applied to encode the transform skipped block.

In one embodiment, when the plurality of states corresponds to 4 states and said one or more target coefficients correspond to one target coefficient, two of the 4 states represent positive sign and remaining two of the 4 states represent negative sign. In another embodiment, when the plurality of states corresponds to 8 states and said one or more target coefficients correspond to one target coefficient, four of the 8 states represent positive sign and remaining four of the 8 states represent negative sign.

In one embodiment, the sign-hiding state of the selected coefficient corresponds to a state of the first or last coefficient of the current segment, or corresponds to a state of the first or last non-zero coefficient of the current segment.

In one embodiment, the predefined number or range of transform coefficients for each of said one or more segments corresponds to N coefficients, one coefficient group, two coefficient groups, four coefficient groups, one transform unit, or one transform block, and wherein N corresponds to 16, 32, 48, or 64.

In one embodiment, said one or more target coefficients in the current segment correspond to a first non-zero coefficient, an M^{th} non-zero coefficient or a last non-zero coefficient in the current segment.

In one embodiment, when said one or more segments correspond to at least two segments, after the quantization coefficients are determined for a first segment, the dependent quantization state is reset to an initial state, or keeping not changed through remaining said target coefficients in the residual block.

In one embodiment, the parity information of the current segment corresponds to a sum of quantization coefficient levels or a sum of absolute quantization coefficient levels. In another embodiment, the parity information of the current segment corresponds to a sum of the states associated with the quantization coefficients.

In one embodiment, said one or more target coefficients in the current segment correspond to two target coefficients. In one embodiment, two signs for the two target coefficients are determined according to the sign-hiding state, the parity information of the current segment, or both. In one embodiment, one of the two signs is determined according to the sign-hiding state and another of the two signs is determined according to the parity information.

In one embodiment, said one or more sign-hiding quantization coefficient levels are allowed when one or more conditions are satisfied. In another embodiment, said one or more conditions comprise a number of non-zero coefficients in the current segment or in the residual block being larger than one or more threshold. In another embodiment, said one or more conditions comprise a distance between the first non-zero coefficient and the last non-zero coefficient in the current segment or in the residual block being larger than one or more threshold.

### BRIEF DESCRIPTION OF THE DRAWINGS

FIG. 1A illustrates an exemplary adaptive Inter/Intra video coding system incorporating loop processing.

FIG. 1B illustrates a corresponding decoder for the encoder in FIG. 1A.

FIG. 2 illustrates an example of Trellis-Coded-Quantization (TCQ) with two scalar quantizers, denoted by Q0 and Q1, and the locations of the available reconstruction levels are uniquely specified by a quantization step size Δ.

FIG. 3 illustrates an example of the finite state machine corresponding to the trellis structure with 4 states used in dependent scalar quantization, where the 4 states (i.e., states 0, 1, 2 and 3 enclosed in circles) and the transition among the states are shown.

FIG. 4 illustrates an example of Trellis-Coded-Quantization (TCQ) structure with 4 states corresponding to FIG. 3.

FIG. 5 illustrates the context modelling and binarization depending on the local neighbourhood, where the small black square represents the current scan position and the grey squares represent the local neighbourhood used.

FIG. 6 illustrates an example of Trellis-Coded-Quantization (TCQ) structure with 8 states.

FIG. 7 illustrates an example of trellis traversing according to an embodiment of the present invention, where sign bit hiding is achieved in dependent quantization based on the last state, and the target sign-hiding coefficient is the first coefficient in the forward scan order.

FIG. 8 illustrates an example of trellis traversing according to an embodiment of the present invention, where sign bit hiding is achieved in dependent quantization based on the last state, and the target sign-hiding coefficient is the last non-zero coefficient in the forward scan order.

FIG. 9 illustrates a flowchart of an exemplary video decoding that utilizes combined dependent quantization and sign bit hiding according to an embodiment of the present invention.

FIG. 10 illustrates a flowchart of an exemplary video encoding that utilizes combined dependent quantization and sign bit hiding according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

### Quantization in VVC

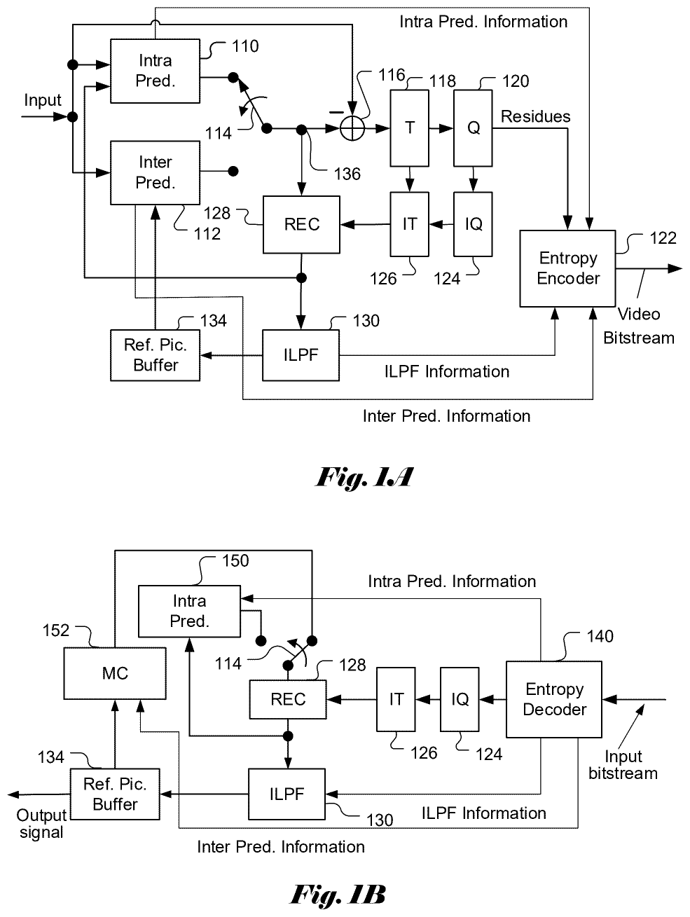

In a typical video coding system, the prediction residues resulted from inter or intra predictions are transform coded by applying transform, quantization and entropy coding to the residues as shown in FIGS. 1A and 1B. The input video data usually are represented in 8/10/12-bit data. However, the transform coefficients of residual data usually use much high data precision, such as 32- or 64-bit data. Quantization is a lossy process (i.e., introducing distortion) that maps the high-precision transform data into a much smaller number of representative quantization levels (i.e., qᵢ) for an input coefficient tᵢ. VVC supports basic quantization (i.e., uniform reconstruction quantizes), in which the set of admissible reconstruction values is specified by a single parameter (i.e., Δ₁). The reconstructed level can be simply derived as t′ᵢ=Δ₁ qᵢ. Similar to previous video coding standards such as HEVC, VVC also adopts quantization weighting matrices by which the quantization step size can be varied across the transform coefficients of a block in order to take into account the human visual sensitivity response to spatial frequency. Therefore, the quantization step size Δ₁ is dependent on the coefficient location i within the block, i.e., Δ₁=aᵢΔ, where aᵢ is a weighting factor depending on the location of the coefficient tᵢ inside the transform block and Δ is a quantization step size. The quantization step size, Δ is used to control bit rate/picture quality. In VVC, a quantization parameter, QP is used to derive the quantization step size.

### Sign Bit Hiding (SBH)

VVC, like HEVC, also supports sign bit hiding as a way to improve quantization performance. During the quantization process, the sign bits associated with non-zero transform coefficients are coded separately from the magnitude of the non-zero transform coefficients. The basic idea of SDH is to skip the coding of the sign for one nonzero coefficient among the non-zero transform coefficients. Instead, the sign for one nonzero coefficient among the non-zero transform coefficients is derived from the parity of the sum of absolute values of the non-zero coefficients. In order to save one sign bit, the encoder needs to adjust the values of the non-zero coefficients to satisfy the parity check condition, which will introduce minor additional distortion. While the term of “the values of the non-zero coefficients” is used here, it is understood that “the values of the non-zero coefficients” refers to “the values of the quantized non-zero coefficients” since the quantized non-zero coefficients can be determined at both the encoder side and the decoder side. Therefore, both the encoder and the decoder can derive the same parity information (i.e., the sum of absolute values of the quantized non-zero coefficients) for sign bit hiding. In the following disclosure, the transform coefficients may refer to quantized transform coefficients wherever appropriate. The SDH usually is use for each coefficient group (CG) in HEVC and VVC.

### Trellis-Coded-Quantization (TCQ)/Dependent Quantization (DQ)

Trellis coded quantization (TCQ), also referred as dependent quantization (DQ) is a combination of trellis structure and set partitioning idea. By finding the path with the smallest cost along the trellis structure, the coded output for a group of samples with the smallest cost measured by MSE and number of bits for signalling can be found.

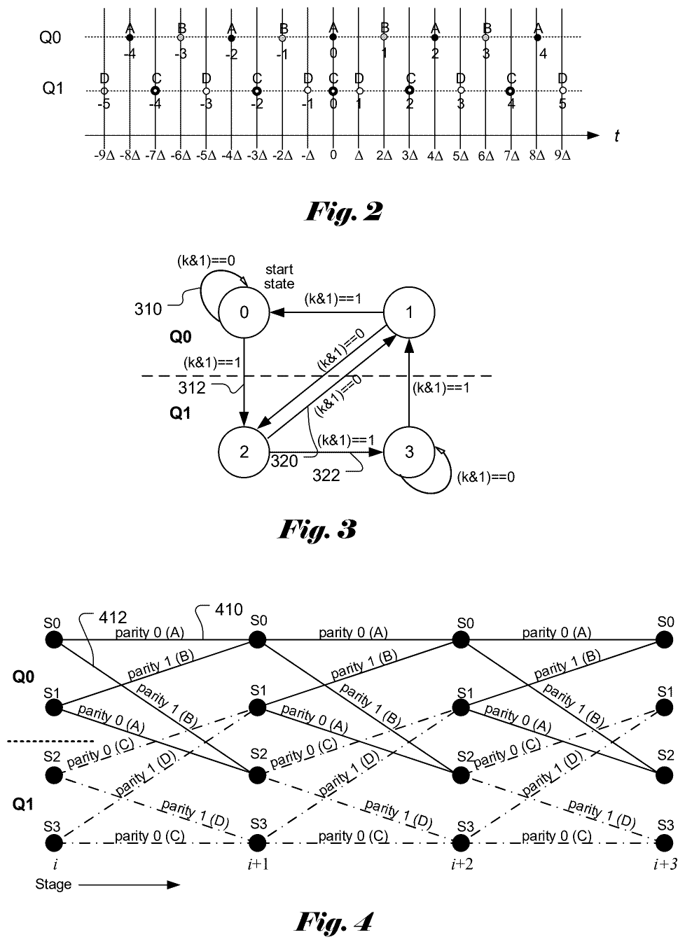

A method was disclosed to apply TCQ to achieve dependent scalar quantization, in which the set of admissible reconstruction values for a transform coefficient depends on the values of the transform coefficient levels that precede the current transform coefficient level in the reconstruction order. FIG. 2 illustrates an example of TCQ with two scalar quantizers, denoted by Q0 and Q1, which are selected according to quantization state as defined by the values of the transform coefficient levels that precede the current transform coefficient level and the previous quantization state. The locations of the available reconstruction levels are uniquely specified by a quantization step size Δ.

The two scalar quantizers Q0 and Q1 are characterized as follows:

Q0: The reconstruction levels (indicated by a black dot or a grey dot in FIG. 2) of the first quantizer Q0 are given by the even integer multiples of the quantization step size Δ (i.e., −8Δ, −6Δ, −4Δ, −2Δ, 0, 2Δ, 4Δ, 6Δ, 8Δ in FIG. 2). When this quantizer is used, a reconstructed transform coefficient t′ is calculated according to:

$${t}^{′} = 2 \cdot k \cdot Δ , k = \{ ... , - 4 , - 3 , - 2 , - 1 , 0 , 1 , 2 , 3 , 4 , ... \}$$

where k denotes the associated transform coefficient level (i.e. transmitted quantization index).

Q1: The reconstruction levels (indicated by a thin-line circle or a thick-line circle in FIG. 2) of the second quantizer Q1 are given by the odd integer multiples of the quantization step size Δ and, in addition, quantizer Q1 also includes the reconstruction level equal to zero. The mapping of transform coefficient levels k to reconstructed transform coefficients t′ is specified by

$${t}^{′} = ( 2 \cdot k - sgn ( k ) ) \cdot Δ , k = \{ ... , - 5 , - 4 , - 3 , - 2 , - 1 , 0 , 1 , 2 , 3 , 4 , 5 , ... \}$$

where sgn(·) denotes the signum function:

$$sgn ( x ) = ( x == 0 ? 0 : ( x < 0 ? - 1 : 1 ) ) .$$

In FIG. 2, the Q0 and Q1 output quantization coefficient levels, k may have even parity or odd parity. For Q0, the output coefficient levels with an even parity (i.e., k&1=0) are labelled as “A” and the output coefficient levels with an odd parity (i.e., k&1=1) are labelled as “B” in FIG. 2. For Q1, the output coefficient levels with an even parity (i.e., k&1=0) are labelled as “C” and the output coefficient levels with an odd parity (i.e., k&1=1) are labelled as “D” in FIG. 2. The scalar quantizer used (Q0 or Q1) is not explicitly signalled in the bitstream. It is determined by the parities of the transform coefficient levels that precede the current transform coefficient in coding/reconstruction order. The quantizer switching is determined by the finite state machine with four states as shown in FIG. 3.

The finite state machine corresponding to the trellis structure used in dependent scalar quantization is shown in FIG. 3. FIG. 3 illustrates the 4 states (i.e., states 0, 1, 2 and 3 enclosed in circles) and the transition among the states. The upper two states, i.e., states 0 and 1, are associated with quantizer Q0 and the lower two states, i.e., states 2 and 3, are associated with quantizer Q1. The operation initially starts with state 0 and Q0 is used to quantize a current coefficient value. If the resulting quantization index has an even parity (i.e., k&1=0), the next state is still state 0 as indicated by transition 310 and quantizer Q0 is used for the next coefficient. If the resulting quantization index has an odd parity (i.e., k&1=1), the next state is state 2 as indicated by transition 312 and quantizer Q1 is used for the next coefficient. For state 2, if the resulting quantization index (Q1 used) has an even parity (i.e., k&1=0), the next state is state 1 as indicated by transition 320 and quantizer Q0 is used for the next coefficient. For state 2, if the resulting quantization index (Q1 used) has an odd parity (i.e., k&1=1), the next state is state 3 as indicated by transition 322 and quantizer Q1 is used for the next coefficient. The state transition for state 1 and state 3 can be determined similarly as shown in FIG. 3.

TABLE 1
Transition table for 4 states

| | |
|---|---|
| Current | Next state for . . . |

| state | (k&1)==0 | (k&1)==1 |
|---|---|---|
| 0 | 0 | 2 |
| 1 | 2 | 0 |
| 2 | 1 | 3 |
| 3 | 3 | 1 |

Table 1 illustrates the transition table corresponding to the state transition diagram of FIG. 3. The transition table shows the next state for a current state depending on the parity of the current quantization index (i.e., k&1).

The quantization process can be represented by a trellis structure with the states defined and the quantization process for the transform coefficients. The encoder will traverse through the trellis structure using the Viterbi algorithm (also known as dynamic programming) to determine a best path for a group of coefficients as shown in FIG. 4. The trellis structure can be generated according to the state transition diagram as shown in FIG. 3. For example, at stage i, state 0 will remain at state 0 if the quantization index satisfies (k&1)==0. The condition, (k&1)==0 corresponds to the quantization index being an even number (i.e., symbol “A” in FIG. 2). Accordingly, state 0 at stage i will go to state 0 at stage i+1 through path 410 (i.e., parity 0 (A)). Similarly, state 0 at stage i will go to state 2 at stage i+1 through path 412 (i.e., parity 1 (B)). Using the same technique, we can determine the rest of the trellis structure in FIG. 4. The trellis structure provides a great advantage in reducing the complexity of searching for a minimum-cost path to quantize a group of coefficients. Since two quantizers may be used to quantize each coefficient, there will be 2ⁿ possible combinations of quantizers selected for n coefficients. To select a best quantizer combination among the 2ⁿ possible combinations would be a formidable task when n is large. However, the trellis structure can reduce the complexity to be linearly dependent on n as to be described below.

During the quantization process, in each stage, the path with the smaller cost for each state will be kept by the encoder. After a new coefficient is quantized, the smaller accumulated cost for each state is updated. Let ADx(i) be the smallest cost for state Sx at stage i, where x=0, 1, 2 or 3. For example, S0 at stage i+1 can be reached from S0 at stage i through the parity 0 (A) path or from S1 at stage i through the parity 1 (B) path. The accumulated cost s from S0 and S1 at stage i are compared and the smaller one is kept for S0 at stage i+1. The same process is applied to other states at stage i+1. Therefore, only one best accumulated cost and associated path is kept for each state. This process continues until all coefficients in a transform block are processed. Therefore, while doing backward traversing, the path can be uniquely determined. Finding the levels for a set of samples with the smallest cost is equivalent to finding the path ends with the smallest cost.

In VVC, the TCQ, also named as dependent quantization (DQ), is adopted as one of the quantization and residual coding tool. In VVC, when TCQ is selected, sign bit hiding is not used since the parity of quantization index is used to generate the state transition for the trellis structure.

### Syntax Signalling and Context Modelling for DQ

A four-pass syntax signalling for coefficients in each CG was disclosed.
pass 1: the following flags are transmitted for each scan position (using the regular mode):
   sig_coeff flag and, when sig_coeff flag is equal to 1, par_level_flag and rem_abs_gt1_flag;
pass 2: for all scan positions with rem_abs_gt1_flag equal to 1, a rem_abs_gt2_flag is coded using the regular mode of the arithmetic coding engine;
pass 3: for all scan positions with rem_abs_gt2_flag equal to 1, the non-binary syntax element abs_remainder is coded in the bypass mode of the arithmetic coding engine;
pass 4: for all scan positions with sig_coeff flag equal to 1, a sign flag is coded in the bypass mode of the arithmetic coding engine.

The context modelling and binarization depends on the following measures for the local neighbourhood as shown in FIG. 5, where the small black square 510 represents the current scan position and the grey squares represent the local neighbourhood used.
numSig: the number of non-zero levels in the local neighbourhood;
sumAbs1: the sum of partially reconstructed absolute levels (absLevel1) after the first pass in the local neighbourhood;
sumAbs: the sum of reconstructed absolute levels in the local neighbourhood;
d=x+y, where x and y are the position in x-axis and y-axis in current transform block (TB) or transform unit (TU) respectively.

The context model of sig_flag depends on current state, which can be derived as follows:
Luma component,

$$ctxIdSig = 18 * max ( 0 , state - 1 ) + min ( sumAbs 1 , 5 ) + ( d < 2 ? 12 : ( d < 5 ? 6 : 0 ) ) .$$

Chroma component

$$ctxIdSig = 12 * max ( 0 , state - 1 ) + min ( sumAbs 1 , 5 ) + ( d < 2 ? 6 : 0 ) ) .$$

The context model of par_level_flag is described as follows:
If the current scan position is equal to the position of the last non-zero level (as indicted by the transmitted x and y coordinates), ctxIdPar is set equal to 0;
Otherwise, if the current colour component is the luma component, the context index is set to:

$$ctxIdPar = 1 + min ( sumAbs 1 - numSig , 4 ) + ( d == 0 ? 15 : ( d < 3 ? 10 : ( d < 10 ? 5 : 0 ) ) ) .$$

Otherwise (the current colour component is the chroma component), the context index is set to

$$ctxIdPar = 1 + min ( sumAbs 1 - numSig , 4 ) + ( d == 0 ? 5 : 0 ) .$$

The context of rem_abs_gtx flag is described as follows:

$$ctxIdGt 1 = ctxIdPar$$

$$ctxIdGt 2 = ctxIdPar$$

The non-binary syntax element abs_remainder is binarized using the same class of Rice codes as in HEVC. The Rice parameter ricePar is determined as follows:
If sumAbs—numSig is less than 12, ricePar is set equal to 0;
Otherwise, if sumAbs—numSig is less than 25, ricePar is set equal to 1;
Otherwise, ricePar is set equal to 2.
   DQ with 8 State

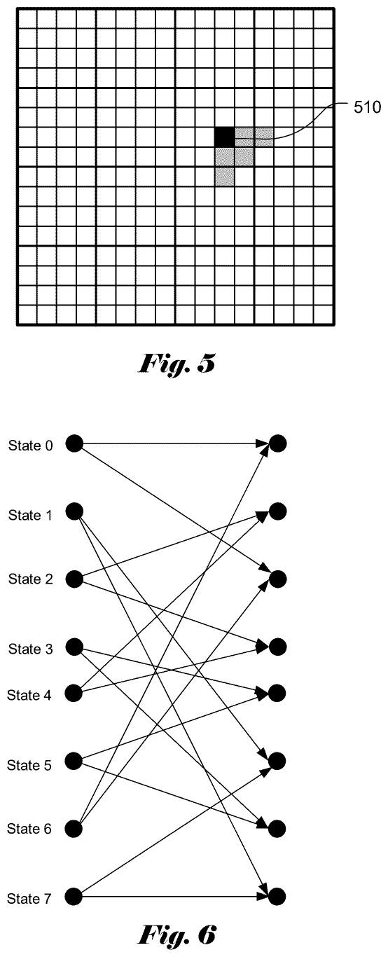

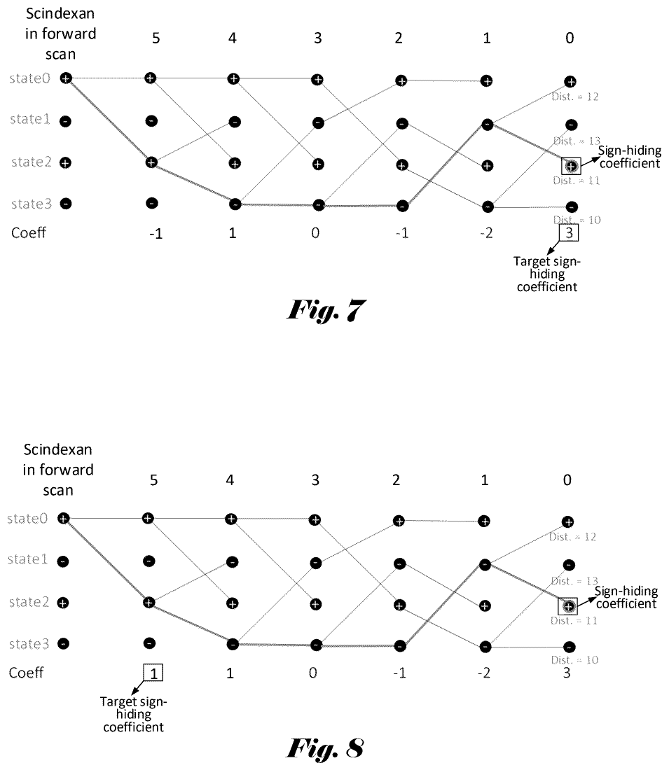

In ECM-4.0 (Muhammed Coban, et al., “Algorithm description of Enhanced Compression Model 4 (ECM 4)”, Joint Video Experts Team (JVET) of ITU-T SG 16 WP 3 and ISO/IEC JTC 1/SC 29, 23rd Meeting, by teleconference, 7-16 Jul. 2021, Document: JVET-Y2025), it supports 8 states DQ. FIG. 6 shows the state transition of 8 state DQ. The state transition table is shown in Table 2. The state number is increased to 8 states. The even states are using Q0, and the odd states are using Q1.

TABLE 2
Transition table for 8 states

| Qstate | Parity = 0 | Parity = 1 |
|---|---|---|
| 0 | 0 | 2 |
| 1 | 5 | 7 |
| 2 | 1 | 3 |
| 3 | 6 | 4 |
| 4 | 2 | 0 |
| 5 | 4 | 6 |
| 6 | 3 | 1 |
| 7 | 7 | 5 |

The TCQ has been adopted in VVC and is also being considered for the next generation international video coding standard. While the TCQ has shown superior performance than the regular uniform quantizer, the TCQ cannot be used with sign bit hiding since the parity of quantization index is used for trellis path decision. In this application, a TCQ that can use sign bit hiding is disclosed to improve the performance of conventional TCQ.

DQ with Sign Bit Hiding

In the present invention, it is proposed to apply sign hiding to DQ. According to a sign-hiding state of a selected coefficient (e.g. the DC coefficient) or a parity information of the quantization coefficients, a sign bit of a target sign-hiding coefficient (e.g. the last non-zero coefficient or the DC coefficient) can be recovered or hidden. When applying the sign-hiding with the DQ, some of the states (e.g. half of states, or more than half of states, or less than half of states) are selected to represent the positive sign for a target coefficient and some of the states (e.g. the other states) are selected to represent the negative sign for the target coefficient. For example, in 4-state DQ, the state 0/1 (i.e., state 0 or 1) can represent the positive sign and the state 2/3 (i.e., state 2 or 3) can represent the negative sign. In another example, the state 0/1 can represent the negative sign and the state 2/3 can represent the positive sign. In another example, the state 0/2 can represent the positive sign and the state 1/3 can represent the negative sign. In another example, the state 0/2 can represent the negative sign and the state 1/3 can represent the positive sign. In another example, the state 0/3 can represent the positive sign and the state 1/2 can represent the negative sign. In another example, the state 0/3 can represent the negative sign and the state 1/2 can represent the positive sign.

In another embodiment, in 8-state DQ, the state 0/7/1/4 can represent the positive (or negative) sign. In another example, the state 2/5/3/6 can represent the positive (or negative) sign. In another example, the state 0/2/4/6 can represent the positive (or negative) sign. In another example, the state 0/2/5/7 can represent the positive (or negative) sign. In another example, the state 0/1/2/3 can represent the positive (or negative) sign.

In DQ, each state can be set to represent a positive coefficient or a negative coefficient. In an encoder, after traverse through a predefined number or range of coefficients, the path with the smallest cost and the sign in the final state equal to the sign value of the target coefficient will be selected. However, while the sign in the final state is mentioned as an example for sign-hiding, the present invention can use any state (referred as a sign-hiding state) of the selected path for sign bit hiding. For example, the sign-hiding state can be the DQ state of the DC coefficient of the TB, the first or last coefficient in a segment or a TB, or the first or last non-zero coefficient in a segment or a TB. The predefined number or range of coefficients can be N coefficients (e.g. N=16, 32, 48, or 64), one CG (or one aligned CG), two CG (or two aligned CG), four CG (or four aligned CG), or one TU/TB. The target sign can be the first significant coefficient (non-zero coefficient) in the range, or the M^{th} significant coefficient, or the last significant coefficient. For example, it can be the non-zero coefficient with the smallest scan index (e.g. DC coefficient) of a TB, or the non-zero coefficient with the smallest scan index of a segment, or the last non-zero coefficient of a TB, or the non-zero coefficient with the largest scan index of a segment.

After selecting the path with correct sign information and with a smaller cost, the DQ can be reset to an initial state, or keep traversing through the rest of the coefficients, or keep traversing through the coefficient whose sign is hidden. An example is shown in FIG. 7. In this example, the target coefficient (i.e., the sign of the target coefficient to be hidden according to one embodiment of the present invention) is the last quantized transform coefficient (in backward scan order, which is the DC coefficient), which is 3. In this example, the sign-hiding state is the DQ state of the DC coefficient, and the state 1/3 represents the negative sign and the state 0/2 represents the positive sign. Note that with sign hiding, only the path ends in the state with correct sign can be selected. Therefore, in this example, path ends in state 2 is selected instead of path ends in state 3 (because state 3 represents a negative sign) even though the cost of the path ends in state 3 is the smaller than path ends in state 2. As mentioned earlier, while the last non-zero coefficient is used as an example, the target coefficient can be any non-zero coefficient in the predefined number or range of coefficients. For example, in FIG. 8, the target coefficient is the last non-zero quantized transform coefficient (in forward scan order, which is the coefficient in scan position 5), which is 1. In this example, the sign-hiding state is the DQ state of the DC coefficient, and the state 1/3 represents the negative sign and the state 0/2 represents the positive sign. Therefore, in this example, path ends in state 2 is selected instead of path ends in state 3 (because state 3 represents a negative sign) even though the cost of the path ends in state 3 is the smaller than path ends in state 2.

For enabling the sign hiding with DQ, some conditions can be defined. When one or more conditions, or all conditions are satisfied, one or more sign bits are hidden in the predefined number or range of coefficients. In one example, for each predefined number or range of coefficients, the number of non-zero coefficients needs to be larger than a threshold. The threshold is an integer, which can be equal to 1, 2, 3, 4, 5, 6, or 7, or equal to 8, 16, 24, or 32. In another example, the distance between the first non-zero coefficient and the last non-zero coefficient, or the distance between the last non-zero coefficient and the first coefficient in this predefined number or range of coefficients needs to be larger than a threshold. The threshold is an integer, which can be equal to 1, 2, 3, 4, 5, 6, or 7, or equal to 8, 16, 24, or 32.

In another embodiment, the sum of coefficients or the sum of absolutely coefficients can be used as a clue to hide the sign. For example, if the sum of absolutely coefficients is an even number, the hidden sign is a positive sign or negative sign. Otherwise (i.e., the sum of absolutely coefficients being an odd number), the hidden sign is a negative sign or positive sign.

In another embodiment, the sum of DQ state of coefficients can be used as a clue to hide the sign. For example, if the sum of DQ state is an even number, the hidden sign is a positive sign or negative sign. Otherwise (i.e., the sum of DQ state being an odd number), the hidden sign is a negative sign or positive sign. In another embodiment, the sum of DQ quantizer number (e.g. the number of quantizer Q0 is 0 and the number of quantizer Q1 is 1) of coefficients can be used as a clue to hide the sign. For example, if the sum of DQ quantizer numbers is an even number, the hidden sign is a positive sign or negative sign. Otherwise (i.e., the sum of DQ quantizer numbers being an odd number), the hidden sign is a negative sign or positive sign. As mentioned earlier, the coefficients here refer to quantized transform coefficients or quantization levels.

In another embodiment, it can hide multiple signs in one selected path. For example, it can hide two signs per TB by the DQ state, a sum of coefficients or a sum of absolutely coefficients, a sum of DQ state of coefficients, or combining the information above. Note that the sum of coefficients, the sum of absolutely coefficients, and the sum of DQ state of coefficients are all related parity information associated with a select path. For example, the state 0/7 represents ++, 1/4 for +−, 2/5 for −+, 3/6 for −−. It means if the selected sign-hiding state (e.g. the state of the DC coefficient in a TB or the state of the coefficient with a smallest scan index in a segment) is 0 or 7, the last significant coefficient and last 2^{nd} significant coefficient sign are all positive signs. In another example, the state 0/2 represents ++, 4/6 for +−, 5/7 for −+, 1/3 for −−. In another example, the state 0/4 represents ++, 2/6 for +−, 5/3 for −+, 1/7 for −−. In another example, the state 0/6 represents ++, 2/4 for +−, 5/1 for −+, 7/3 for −−.

In another embodiment, the sum of absolutely coefficients mod 4 (i.e., modulo 4) equal to 0 represents ++, equal to 1 represents +−, equal to 2 represents −+, equal to 3 represents −−.

In another embodiment, the state and parity information can be used jointly to hiding the sign information. For example, some of the states (e.g. 0/7/1/4) represent the positive or negative sign for the last significant coefficient sign, and the parity of sum of absolutely coefficients represents the sign of the second last significant coefficient sign.

In another example, some of the states (e.g. 0/7/1/4) represent the positive or negative sign for the second last significant coefficient sign, and the parity of sum of absolutely coefficients represent the sign of the last significant coefficient sign.

For enabling the second sign bit hiding, a different threshold can be used. For example, the predefined number or range, the number of non-zero coefficients in the range, and/or the distance between the non-zero coefficients in the range can be different from the condition of hiding the first sign. The threshold can be larger than, or equal to, or larger than or equal to, or smaller than, or smaller than or equal to the threshold of the first sign.

In another embodiment, the sign hiding condition or threshold can be different for the chroma component. The values can be different from the threshold of luma component.

Any of the foregoing proposed methods can be applied to transformed TB or transform skipped TB.

Any of the foregoing proposed methods of TCQ with sign bit hiding can be implemented in encoders and/or decoders. For example, any of the proposed methods of TCQ with sign bit hiding can be implemented in a quantization module (e.g. Q 120 in FIG. 1A), de-quantization module (e.g. IQ 124 in FIG. 1A) and residual coding module of an encoder, and/or a de-quantization module (e.g. IQ 124 in FIG. 1B) and residual coding module of a decoder. Alternatively, any of the proposed methods can be implemented as a circuit coupled to the quantization module, de-quantization module and residual coding module of the encoder and/or the de-quantization module and residual coding module of the decoder, so as to provide the information needed by the predictor derivation module. The modules for implementing the TCQ with sign bit hiding associated with the present invention may also correspond to executable software or firmware codes stored on a media, such as hard disk or flash memory, for a CPU (Central Processing Unit) or programmable devices (e.g. DSP (Digital Signal Processor) or FPGA (Field Programmable Gate Array)).

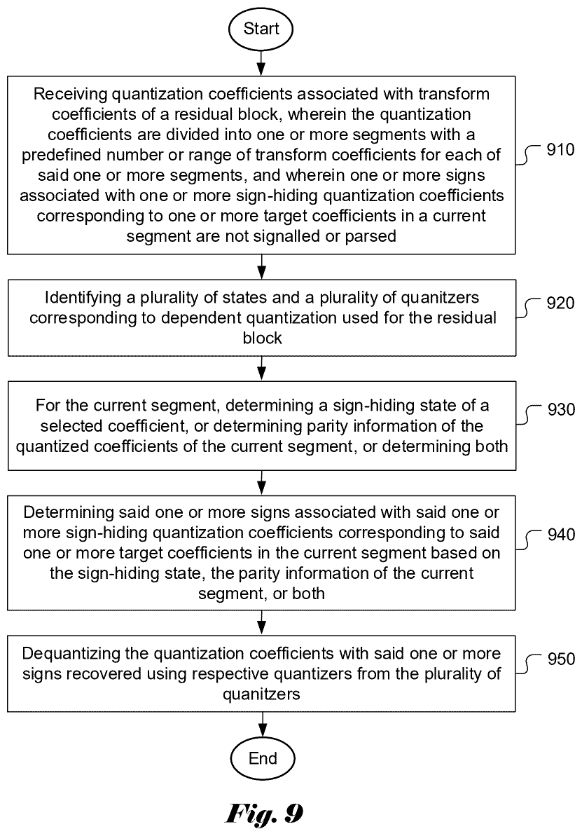

FIG. 9 illustrates a flowchart of an exemplary video decoding that utilizes combined dependent quantization and sign bit hiding according to an embodiment of the present invention. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to this method, quantization coefficients associated with transform coefficients of a residual block are received in step 910, wherein the quantization coefficients are divided into one or more segments with a predefined number or range of transform coefficients for each of said one or more segments, and wherein one or more signs associated with one or more sign-hiding quantization coefficients corresponding to one or more target coefficients in a current segment are not signalled or parsed. A plurality of states and a plurality of quantizers corresponding to dependent quantization used for quantizing transform coefficients of the residual block are identified in step 920. For the current segment, a sign-hiding state of a selected coefficient is determined, or parity information of the quantized coefficients of the current segment is determined, or both are determined in step 930. Said one or more signs associated with said one or more sign-hiding quantization coefficients corresponding to said one or more target coefficients in the current segment are determined based on the sign-hiding state, the parity information of the current segment, or both and determined in step 940. The quantization coefficients with said one or more signs recovered are dequantized using respective quantizers from the plurality of quantizers in step 950.

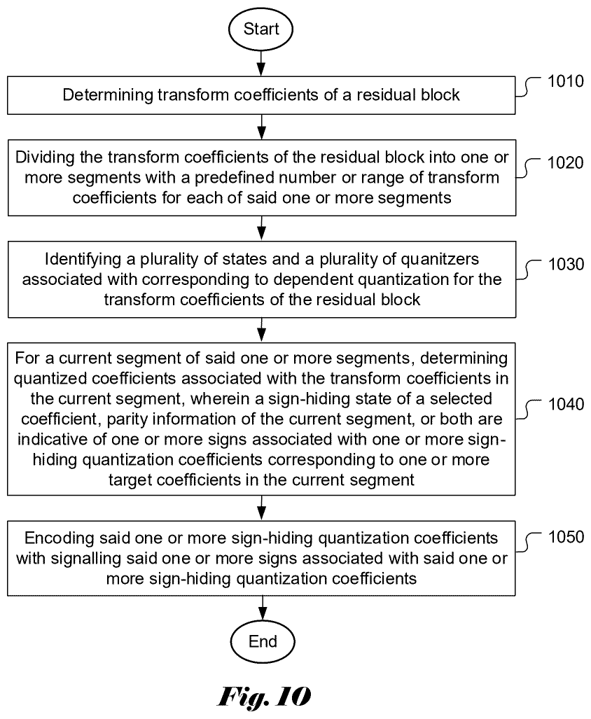

FIG. 10 illustrates a flowchart of an exemplary video encoding that utilizes combined dependent quantization and sign bit hiding according to an embodiment of the present invention. According to the method, at an encoder side, transform coefficients of a residual block are determined in step 1010. The transform coefficients of the residual block are divided into one or more segments with a predefined number or range of transform coefficients for each of said one or more segments in step 1020. A plurality of states and a plurality of quantizers corresponding to dependent quantization for the transform coefficients of the residual block are identified in step 1030. For a current segment of said one or more segments, the quantized coefficients associated with the transform coefficients in the current segment is determined in step 1040, wherein a sign-hiding state of a selected coefficient, parity information of the current segment, or both are indicative of one or more signs associated with one or more sign-hiding quantization coefficients corresponding to one or more target coefficients in the current segment. Said one or more sign-hiding quantization coefficients are encoded without signalling said one or more signs associated with said one or more sign-hiding quantization coefficients in step 1050.

The flowcharts shown are intended to illustrate examples of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of dequantizing quantized transform coefficients for processing video data, the method comprising:
receiving quantization coefficients associated with transform coefficients of a residual block, wherein the quantization coefficients are divided into one or more segments with a predefined number or range of transform coefficients for each of said one or more segments, and wherein one or more signs associated with one or more sign-hiding quantization coefficients corresponding to one or more target coefficients in a current segment are not signalled or parsed;
identifying a plurality of states and a plurality of quantizers corresponding to dependent quantization used for the residual block;
for the current segment, determining a sign-hiding state of a selected coefficient, or determining parity information of the quantized coefficients of the current segment, or determining both;
determining said one or more signs associated with said one or more sign-hiding quantization coefficients corresponding to said one or more target coefficients in the current segment based on the sign-hiding state, the parity information of the current segment, or both; and
dequantizing the quantization coefficients with said one or more signs recovered using respective quantizers from the plurality of quantizers.

2. The method of claim 1, wherein when the plurality of states corresponds to 4 states and said one or more target coefficients correspond to one target coefficient, two of the 4 states represent positive sign and remaining two of the 4 states represent negative sign.

3. The method of claim 1, wherein when the plurality of states corresponds to 8 states and said one or more target coefficients correspond to one target coefficient, four of the 8 states represent positive sign and remaining four of the 8 states represent negative sign.

4. The method of claim 1, wherein the sign-hiding state of the selected coefficient corresponds to a state of first or last coefficient of the current segment, or corresponds to a state of first or last non-zero coefficient of the current segment.

5. The method of claim 1, wherein the predefined number or range of transform coefficients for each of said one or more segments corresponds to N coefficients, one coefficient group, two coefficient groups, four coefficient groups, one transform unit, or one transform block, and wherein N corresponds to 16, 32, 48, or 64.

6. The method of claim 1, wherein said one or more target coefficients in the current segment correspond to a first non-zero coefficient, an Mth non-zero coefficient or a last non-zero coefficient in the current segment.

7. The method of claim 1, wherein when said one or more segments correspond to at least two segments, after the quantization coefficients are determined for a first segment, a dependent quantization state is reset to an initial state, or keeping not changed through remaining said target coefficients in the residual block.

8. The method of claim 1, wherein the parity information of the current segment corresponds to a sum of quantization coefficient levels or a sum of absolute quantization coefficient levels.

9. The method of claim 1, wherein the parity information of the current segment corresponds to a sum of states associated with the quantization coefficients.

10. The method of claim 1, wherein said one or more target coefficients in the current segment correspond to two target coefficients.

11. The method of claim 10, wherein two signs for the two target coefficients are determined according to the sign-hiding state, the parity information of the current segment, or both.

12. The method of claim 11, wherein one of the two signs is determined according to the sign-hiding state and another of the two signs is determined according to the parity information of the current segment.

13. The method of claim 1, wherein said one or more sign-hiding quantization coefficients are allowed when one or more conditions are satisfied.

14. The method of claim 13, wherein said one or more conditions comprise a number of non-zero coefficients in the current segment or in the residual block being larger than one or more threshold.

15. The method of claim 13, wherein said one or more conditions comprise a distance between the first non-zero coefficient and the last non-zero coefficient in the current segment or in the residual block being larger than one or more threshold.

16. A method of quantizing transform coefficients for processing video data, the method comprising:
determining transform coefficients of a residual block;
dividing the transform coefficients of the residual block into one or more segments with a predefined number or range of transform coefficients for each of said one or more segments;
identifying a plurality of states and a plurality of quantizers associated with corresponding to dependent quantization for the transform coefficients of the residual block;
for a current segment of said one or more segments, determining quantized coefficients associated with the transform coefficients in the current segment, wherein a sign-hiding state of a selected coefficient, parity information of the current segment, or both are indicative of one or more signs associated with one or more sign-hiding quantization coefficients corresponding to one or more target coefficients in the current segment; and
encoding said one or more sign-hiding quantization coefficients with signalling said one or more signs associated with said one or more sign-hiding quantization coefficients.

17. An apparatus for dequantizing quantized transform coefficients for processing video data, the apparatus comprising one or more electronics or processors arranged to:
receive quantization coefficients associated with transform coefficients of a residual block, wherein the quantization coefficients are divided into one or more segments with a predefined number or range of transform coefficients for each of said one or more segments, and wherein one or more signs associated with one or more sign-hiding quantization coefficients corresponding to one or more target coefficients in a current segment are not signalled or parsed;
identify a plurality of states and a plurality of quantizers corresponding to dependent quantization used for the residual block;
for the current segment, determine a sign-hiding state of a selected coefficient, or determining parity information of the quantized coefficients of the current segment, or determining both;
determine said one or more signs associated with said one or more sign-hiding quantization coefficients corresponding to said one or more target coefficients in the current segment based on the sign-hiding state, the parity information of the current segment, or both; and
dequantize the quantization coefficients with said one or more signs recovered using respective quantizers from the plurality of quantizers.

18. An apparatus of quantizing transform coefficients for processing video data, the apparatus comprising one or more electronics or processors arranged to:
determine transform coefficients of a residual block;
divide the transform coefficients of the residual block into one or more segments with a predefined number or range of transform coefficients for each of said one or more segments;
identify a plurality of states and a plurality of quantizers associated with corresponding to dependent quantization for the transform coefficients of the residual block;
for a current segment of said one or more segments, determine quantized coefficients associated with the transform coefficients in the current segment, wherein a sign-hiding state of a selected coefficient, parity information of the current segment, or both are indicative of one or more signs associated with one or more sign-hiding quantization coefficients corresponding to one or more target coefficients in the current segment; and
encode said one or more sign-hiding quantization coefficients with signalling said one or more signs associated with said one or more sign-hiding quantization coefficients.
